(19) United States
(12) Patent Application Publication
(10) Pub. No.: US 2009/0019976 A1
(43) Pub. Date: Jan. 22, 2009

(54) HAND TOOL WITH ENCLOSING COVER

(76) Inventor: Chih-Ching HSIEH, Fengyuan City (TW)

Correspondence Address: SINORICA, LLC, 528 FALLSGROVE DRIVE, ROCKVILLE, MD, 20850, US

(21) Appl. No.: 11/778,656

(22) Filed: Jul. 17, 2007

(51) Int. Cl. B25G 1/10

(52) U.S. Cl. 81/489; 16/421

(57) ABSTRACT

A hand tool with an enclosing cover comprises: a driving portion; a holding portion; a cover layer enclosing the holding portion with a seaming track being formed in the cover layer so that the user can hold the hand tool firmly. The cover layer has an inner surface and an outer surface; the inner surface adheres upon an outer surface of the holding portion. The cover layer encloses the holding portion with a part of the cover layer overlaps another part of the cover layer and thus an overlapping line is formed at the connection of the two parts. The track is formed as a plurality of rhombuses which are arranged linearly and the overlapping line passes through the two opposite apexes of each rhombus and this the track is symmetric with respect to the overlapping line.

### FIELD OF THE INVENTION

The present invention relates to hand tools, and particularly to a hand tool with an enclosing cover, wherein a hand tool with an enclosing cover comprises: a driving portion; a holding portion; a cover layer enclosing the holding portion with a seaming track being formed in the cover layer so that the user can hold the hand tool firmly.

### BACKGROUND OF THE INVENTION

Generally, the hand tools, such as spanners, are made integrally by metal or alloy. The holding portion of the tool has a smooth surface. As a result, it can not provide sufficient friction force to user's hand. To have great friction force, a cloth is used to enclose the holding portion of the hand tool, but the cloth often shields the view of the user so that the user can not view the work piece clearly. Furthermore the cloth has uniform thickness and thus the user can not operate the tool comfortable.

Thus, some improvements are provided. On kind of improvement structure provides a plurality of small particles for increasing friction force to the hand holding the hand tool. However, the particles will accumulate pressures so that the user's hand will feel ache and uncomfortable. Furthermore the metal is good heat and electric conductor so that as it is used in some environments, such as used to drive some very hot objects, the heat will transfer to the user's hand.

### SUMMARY OF THE INVENTION

Accordingly, the primary object of the present invention is to provide a hand tool with an enclosing cover, wherein a hand tool with an enclosing cover comprises: a driving portion; a holding portion; a cover layer enclosing the holding portion with a seaming track being formed in the cover layer so that the user can hold the hand tool firmly.

To achieve above objects, the present invention provides a hand tool with an enclosing cover comprising: a driving portion; a holding portion; a cover layer enclosing the holding portion with a seaming track being formed in the cover layer so that the user can hold the hand tool firmly. The cover layer has an inner surface and an outer surface; the inner surface adheres upon an outer surface of the holding portion. The cover layer encloses the holding portion with a part of the cover layer overlaps another part of the cover layer and thus an overlapping line is formed at the connection of the two parts. The track is formed as a plurality of rhombuses which are arranged linearly and the overlapping line passes through the two opposite apexes of each rhombus and this the track is symmetric with respect to the overlapping line. The hand tool is one of a socket spanner, an adjustable spanner, an opening head spanner, and a ring spanner. The cover layer is an elastic sheet with a material of such as leather, rubber, plastics, fiber, fabrics, manmade leather, or other material which is soft and flexible.

The various objects and advantages of the present invention will be more readily understood from the following detailed description when read in conjunction with the appended drawing.

### BRIEF DESCRIPTION OF THE DRAWINGS

FIG. 1 is an exploded perspective view of the hand tool with an enclosing of the present invention.

FIG. 2 is a lateral schematic view of the hand tool with an enclosing cover of the present invention.

FIG. 3 is a schematic view about the hand tool with an enclosing cover of the present invention.

FIG. 4 is a schematic view showing the operation of the present invention.

FIG. 5 is a schematic perspective view about the second embodiment of the present invention.

FIG. 6 is a schematic perspective view about the third embodiment of the present invention.

FIG. 7 shows about enclosing way for the spanner illustrated in FIG. 5.

FIG. 8 shows about enclosing way for the spanner illustrated in FIG. 6.

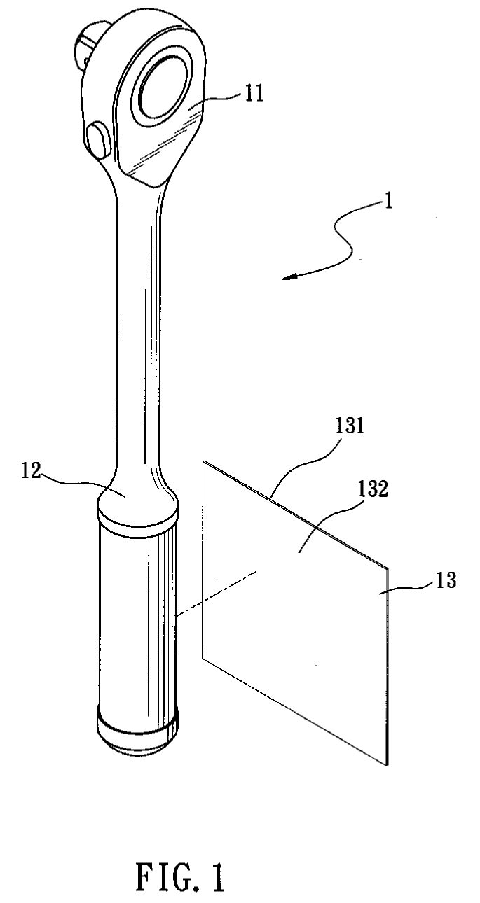

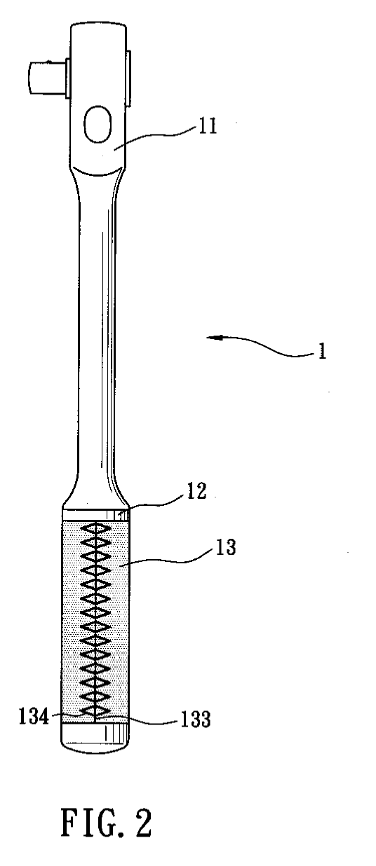

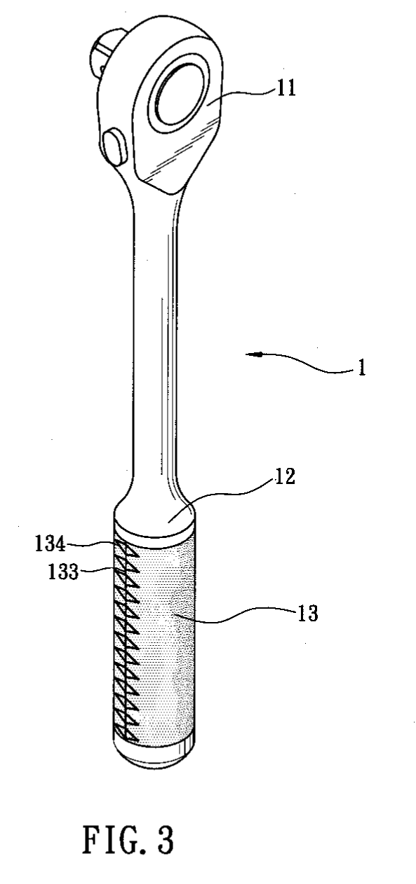

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

A hand tool 1 with an enclosing cover of the present invention is illustrated. The present invention has the following elements.

The hand tool 1 has a driving portion 11 and a holding portion 12.

A cover layer 13 encloses the holding portion 12. The cover layer 13 is an elastic sheet with a material of such as leather, rubber, plastics, fiber, fabrics, manmade leather, or other material which are soft and flexible. The cover layer 13 has the properties of lower and high temperature endurance, and wear and collision proof and anti-static-electricity.

The cover layer 13 has an inner surface 132 and an outer surface 131. The inner surface 132 adheres upon an outer surface of the holding portion 12.

The cover layer 13 encloses the holding portion 12 with a part of the cover layer 13 overlaps another part of the cover layer 13 and thus an overlapping line 133 is formed at the connection of the two parts.

A seaming wire serves to seam the two parts together so as to form a track 134. The track 134 is formed as a plurality of rhombuses which are arranged linearly and the overlapping line 133 passes through the two opposite apexes of each rhombus and this the track 134 is symmetric with respect to the overlapping line 133.

By the properties of lower and high temperature endurance, wear and collision proof and anti-static-electricity of the cover layer 13, the users hand with preventing from scald, frostbite, and electric shock. Furthermore the elasticity of the cover layer 13 makes the user feel comfortable. The tracks 134 provide friction force to user's hand so that the user can hold the hand tool firmly.

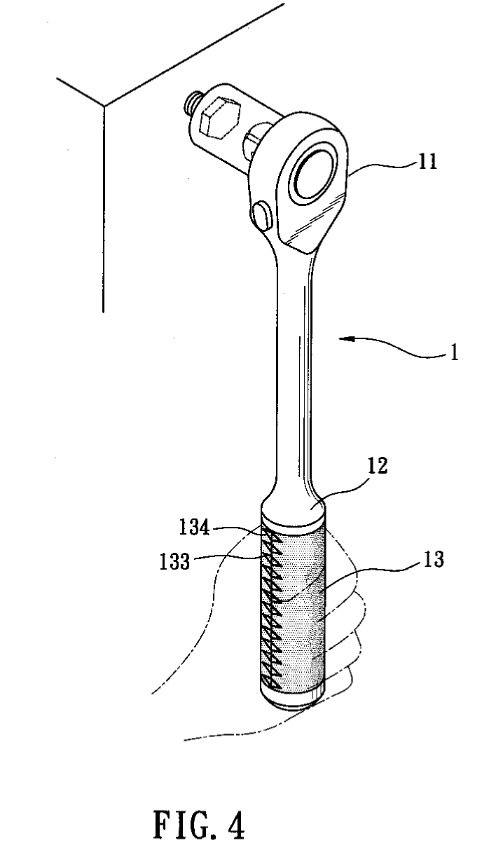

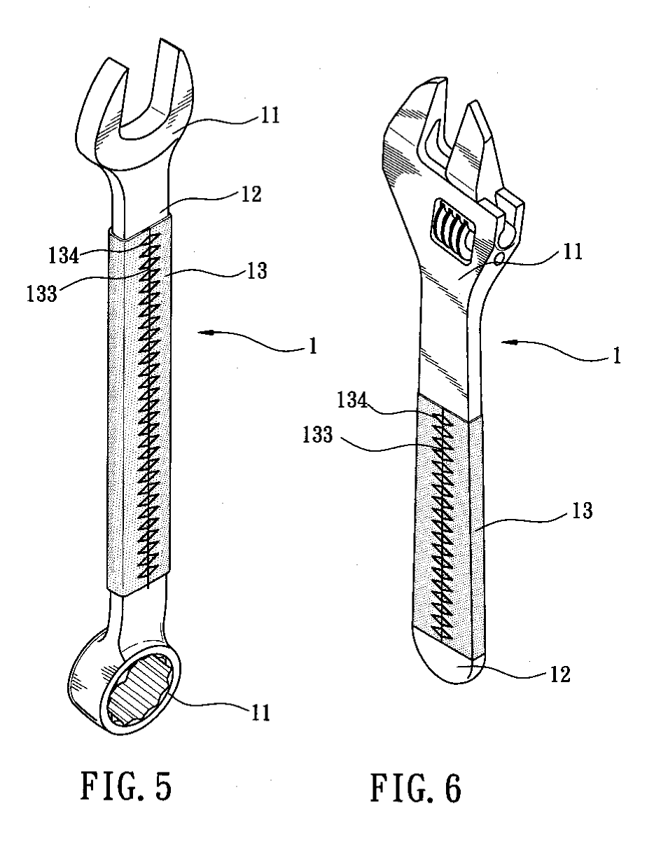

Referring to FIGS. 4, 5, 6, 7 and 8, the schematic view about the operation of the present invention is illustrated. In FIG. 4, it is illustrated that the present invention is used to a socket spanner. In FIG. 5, it is illustrated that the present invention is used to a spanner with two driving portions, one is an opened driving portion and another one is a ring driving portion 11.

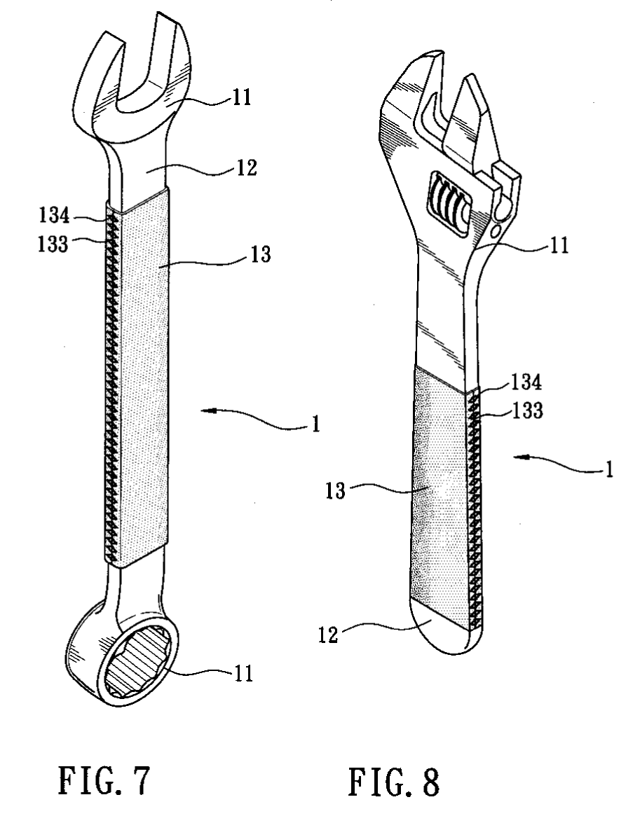

In FIGS. 5 and 7, it is illustrated that the present invention is applied to a spanner with two driving portions, one is an opened driving portion and another one is a ring driving portion 11. In FIG. 5, the track 134 is at a wide side of the holding portion 12. In FIG. 7, the track 134 is at narrow side of the holding portion 12.

In FIGS. 6 and 8, it is illustrated that the present invention is applied to an adjustable spanner. In FIG. 6, the track 134 is at a wide side of the holding portion 12. In FIG. 8, the track 134 is at narrow side of the holding portion 12.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A hand tool with an enclosing cover comprising:
a driving portion;
a holding portion;
a cover layer enclosing the holding portion with a seaming track being formed in the cover layer so that the user can hold the hand tool firmly.

2. The hand tool with an enclosing cover as claimed in claim 1, wherein the cover layer has an inner surface and an outer surface; the inner surface adheres upon an outer surface of the holding portion.

3. The hand tool with an enclosing cover as claimed in claim 1, wherein the cover layer encloses the holding portion with a part of the cover layer overlaps another part of the cover layer and thus an overlapping line is formed at the connection of the two parts.

4. The hand tool with an enclosing cover as claimed in claim 1, wherein the track is formed as a plurality of rhombuses which are arranged linearly and the overlapping line passes through the two opposite apexes of each rhombus and this the track is symmetric with respect to the overlapping line.

5. The hand tool with an enclosing cover as claimed in claim 1, wherein the hand tool is one of a socket spanner, an adjustable spanner, an opening head spanner, and a ring spanner.

6. The hand tool with an enclosing cover as claimed in claim 1, wherein the cover layer is an elastic sheet with a material selected from leather, rubber, plastics, fiber, fabrics, manmade leather, or other material which is soft and flexible.
